(19) United States
(12) Patent Application Publication
(10) Pub. No.: US 2024/0416265 A1
(43) Pub. Date: Dec. 19, 2024

(54) FILTER STRUCTURE

(71) Applicant: TOYO ALUMINIUM EKCO PRODUCTS CO., LTD., Osaka (JP)

(72) Inventors: Kaho Futagami, Osaka (JP); Asami Hosori, Osaka (JP); Hirofumi Yamasaki, Osaka (JP)

(21) Appl. No.: 18/744,854

(22) Filed: Jun. 17, 2024

(30) Foreign Application Priority Data
Jun. 19, 2023 (JP) 2023-099958
May 28, 2024 (JP) 2024-086139

(51) Int. Cl. B01D 46/10; B01D 46/00

(52) U.S. Cl. CPC B01D 46/10; B01D 46/0028; B01D 46/0086; B01D 2265/04; B01D 2275/205; B01D 2279/35; B01D 2279/65

(57) ABSTRACT

A filter structure is provided which has a rectangular shape in plan view, and which includes a filter body, an adhesive layer and a release sheet. The filter body incudes, at its four corners, pinched portions on which the adhesive layer is not formed. Each of the pinched portions has a width defined by a distance between the outer edge of the filter body and the outer edge of the adhesive layer, and the distance is 9 mm or more and 35 mm or less. By pinching one of the pinched portions, it is possible to separate the release sheet from the filter body.

### TECHNICAL FIELD

The present invention relates to a filter structure that is bonded to an intake ventilation device, and that filters the gas passing through the filter structure.

### BACKGROUND ART

As in the below-identified Patent Documents 1 to 3, a filter structure is known which is attached to an intake ventilation device (such as a range hood, a ventilation fan, an air vent, an electric fan, a circulator, an air purifier or an air conditioner), and which filters the air passing through the filter structure, thereby preventing the intake ventilation device from becoming dirty.

Such a filter structure includes a sheet-shaped filter body formed of a nonwoven fabric or the like; and an adhesive layer formed on one surface of the filter body, and formed of an adhesive agent.

Normally, a release sheet having a small thickness is bonded on the surface of the adhesive layer so that while the filter structure is not in use, the adhesive layer is prevented from being unintentionally bonded to an article other than the intake ventilation device.

In order to attach the filter structure to an object for attachment such as a range hood or an air conditioner, a user first removes the release sheet so as to expose the adhesive layer; next aligns the adhesive layer with an attachment portion; and then pressure-bonds the adhesive layer.

In such a filter structure, the filter body of a nonwoven fabric or the like, the adhesive layer on the filter body, and the release sheet, which is laminated on the adhesive layer, are all small in thickness.

In order to prevent the outer edge of the filter body from floating away from the bonding portion of the intake ventilation device, the adhesive layer extends to a portion quite near the outer edge of the filter body. The release sheet is laminated on the adhesive layer such that the outer edge of the release sheet substantially coincides in position with the outer edge of the filter body.

Therefore, when using the filter structure, a user needs to peel up the release sheet, e.g., by hooking his/her fingernail to only the release sheet from among three layers, i.e., the filter body, the adhesive layer and the release sheet of small thickness stacked together such that their outer edges substantially coincide with each other in position, and this is difficult.

In this respect, the filter structure is generally manufactured by forming an adhesive layer on one surface of a roll-shaped release sheet in advance, and laminating onto one surface of a roll-shaped filter body the surface of the release sheet on which the adhesive layer is formed, thereby transferring the adhesive layer to the filter body.

At this time, assuming that the filter structure after lamination is cut to desired dimensions using a slitting blade, in order to prevent an adhesive agent from adhering to the slitting blade, an attempt is made not to form the adhesive layer in a small area of about 5 mm to the outer edge of the filter body, i.e., an attempt is made to form, as a non-adhesive layer, a gusset portion along the outer edge of the filter body.

If a gusset portion is formed, it seems that a use can easily peel up the release sheet from the gusset portion, but in reality, there are many cases where the distance between the outer edge of the adhesive layer and the outer edge of the filter structure is extremely short (their outer edges are extremely close to each other) due to variations in the dimensions at the time of cutting.

In such a case, the gusset portion is hardly present, thus making it difficult to find the portion of the release sheet from which the release sheet is to be separated. Therefore, a user cannot easily hook his/her fingernail or finger to the release sheet, and thus cannot easily peel up only the release sheet as in the filter structure that does not include a gusset portion.

Also, for example, if the intake ventilation device is a ventilation opening (ventilation fan) installed in the ceiling of a toilet or a changing room, it is difficult to separate the filter structure after use from the ventilation opening, because the width of the gusset portion, on which the adhesive layer is not formed, is narrow and this separation is conducted at a high place.

### PRIOR ART DOCUMENT(S)

### Patent Document(s)

Patent document 1: Japanese Unexamined Patent Application Publication No. 2002-85927
Patent document 2: Japanese Unexamined Patent Application Publication No. 2017-15297
Patent document 3: Japanese Unexamined Patent Application Publication No. 2021-146274

### SUMMARY OF THE INVENTION

### Problems to be Solved by the Invention

On the other hand, if the thickness of the release sheet is increased, a user can easily hook his/her finger to the release sheet, and easily peel up the release sheet from the filter structure, but the rigidity of the release sheet per se is increased.

Due to this, adhesion of the release sheet to the filter body on which the adhesive layer is formed is reduced during production, and thus when winding the filter structure before cutting or when folding the filter structure in the packaging step, the release sheet could partially separate from the adhesive layer of the filter structure.

Also, compared to a filter structure in which a release sheet of small thickness is used, the material cost is high, and it is difficult to provide the filter structure as a product at a low price.

If the area of the filter body which is along the outer edge thereof and on which the adhesive layer is not formed, i.e., the gusset portion is enlarged, a user can easily peel up the release sheet, but the entire adhesive layer will be displaced toward the center of the filter. Therefore, the adhesive layer will be disposed at a main ventilation portion over a wide area, and this could reduce the ventilation capacity of the intake ventilation device.

Also, if the area of the gusset portion is increased, in a case where the intake ventilation device is a ventilation opening (ventilation fan) installed in the ceiling of a toilet or a changing room, the frame of the ventilation opening does not have a flat shape, and has a rounded shape at the portion around the end in most cases. Therefore, the adhesion of the filter structure to the ventilation opening is reduced and the filter structure could fall off starting from the non-adhesive layer.

In view of the above, it is an object of the present invention to provide a filter structure in which even if a thin release sheet is used, the release sheet can be separated easily, and which does not fall off from an intake ventilation device, thus preventing a reduction in the ventilation capacity of the intake ventilation device.

### Means for Solving the Problems

In order to achieve the above object, the present invention provides a filter structure having a polygonal shape in plan view and comprising at least: a filter body; an adhesive layer partially formed on one surface of the filter body, and formed of an adhesive agent; and a release sheet laminated on the adhesive layer, wherein the filter body includes at least one pinched portion which is in contact with a portion of an outer edge of the filter body, and on which the adhesive layer is not formed, and wherein the at least one pinched portion has a width defined by a distance A between the outer edge of the filter body and an outer edge of the adhesive layer, which is located inwardly of the outer edge of the filter body, and the distance A is 9 mm or more and 35 mm or less. Also, the present invention provides a filter structure having a circular shape in plan view and comprising at least: a filter body; an adhesive layer partially formed on one surface of the filter body, and formed of an adhesive agent; and a release sheet laminated on the adhesive layer, wherein the filter body includes a pinched portion which is in contact with a portion of an outer edge of the filter body, and on which the adhesive layer is not formed, and wherein the pinched portion has a width defined by a distance A between the outer edge of the filter body and an outer edge of the adhesive layer, which is located inwardly of the outer edge of the filter body, and the distance A is 5 mm or more and 35 mm or less.

With this arrangement, even if the release sheet is a thin sheet, it is possible to easily separate the release sheet from the filter body by pinching the moderate-sized at least one pinched portion or pinched portion.

Similarly, when separating the filter structure from, e.g., an intake ventilation device which is located at a high place, it is possible to easily separate the filter structure starting from the at least one pinched portion or the pinched portion.

Also, with this arrangement, the width of the at least one pinched portion or the pinched portion has a size that enables a user to easily pinch the at least one pinched portion or the pinched portion, but that does not allow the filter body to separate starting from the at least one pinched portion or the pinched portion over time after the filter structure is bonded to an intake ventilation device.

Therefore, it is possible to prevent the filter structure from falling off from the intake ventilation device.

Also, with this arrangement, since the at least one pinched portion or the pinched portion has a slight size, the presence of the at least one pinched portion or the pinched portion does not cause the adhesive layer to be displaced toward the center of the filter structure to a large degree.

Therefore, it is also possible to avoid a situation where the presence of the at least one pinched portion or the pinched portion becomes an obstacle, thereby adversely affecting the ventilation performance of the intake ventilation device.

It is possible to realize such effects by setting the distance A of the at least one pinched portion or the pinched portion within the above range.

If the distance A of the at least one pinched portion or the pinched portion is more than 35 mm, the dimensions of the at least one pinched portion or the pinched portion will be too large, so that if the filter structure is attached to an intake ventilation device having a rounded outer edge, the filter structure could separate starting from the at least one pinched portion or the pinched portion over time, and fall off. Also, this causes the filter structure to fold and wrinkle starting from the at least one pinched portion or the pinched portion during packaging, so that the release sheet could separate from the adhesive layer before use. Also, the effective ventilation area of the filter body could decrease. The effective ventilation area of the filter body refers to the area of the portion of the filter body that substantially functions to catch dust, oil stains, etc. with respect to the total area of the filter body in plan view when the filter body is attached to an intake ventilation device. If the area of this portion of the filer body is equal to the total area of the filter body in plan view, the effective ventilation area of the filter body decreases as the distance A of the at least one pinched portion or the pinched portion or a distance B of at least one gusset portion or a gusset portion, which is described later, increases.

If the filter structure has a circular shape in plan view and the distance A of the pinched portion is less than 5 mm, or if the filter structure has a polygonal shape in plan view and the distance A of the at least one pinched portion is less than 9 mm, the dimensions of the pinched portion or the at least one pinched portion is too small, and this could make it difficult to pinch the pinched portion or the at least one pinched portion and separate the release sheet.

In the filter structure of the present invention, it is preferable (i) that the filter body further includes, at an area other than the at least one pinched portion, at least one gusset portion which extends along the outer edge of the filter body, and on which the adhesive layer is not formed, or the filter body further includes, at an area other than the pinched portion, a gusset portion which extends along the outer edge of the filter body, and on which the adhesive layer is not formed, and (ii) that the at least one gusset portion or the gusset portion has a width defined by a distance B between the outer edge of the filter body and the outer edge of the adhesive layer, which is located inwardly of the outer edge of the filter body, and the distance B is set to satisfy “distance B<distance A”.

With this arrangement, when the filter structure is cut to desired dimensions using a slitting blade in a general step of manufacturing the filter structure, since an adhesive agent does not adhere to the slitting blade, productivity is not affected.

Also, since the at least gusset portion or the gusset portion has a wide smaller than that of the at least one pinched portion or the pinched portion, the filter structure does not separate and fall off from the intake ventilation device starting from the at least one gusset portion or the gusset portion.

In the filter structure of the present invention, it is preferable that the distance A of the at least one pinched portion or the pinched portion is 9 mm or more and 30 mm or less, and the distance B of the at least one gusset portion or the gusset portion is 1 mm or more and 8 mm or less.

If the distance B of the at least one gusset portion or the gusset portion is set within the above range, even if there are reasonable variations in the dimensions of the filter structure, it is possible to more reliably prevent the adhesive agent of the adhesive layer from adhering to the slitting blade during cutting.

Also, it is possible to more reliably prevent the filter structure from separating and falling off from the intake ventilation device starting from the at least one gusset portion or the gusset portion.

If the distance B is less than 1 mm, the width of the at least one gusset portion or the gusset portion will be too small, so that a situation could occur where depending on variations in the dimensions of the filter structure, an adhesive agent adheres to the slitting blade, and the blade cannot cut the filter structure smoothly, thereby affecting the productivity of the filter structure.

If the distance B is more than 9 mm, when attaching the filter body to an intake ventilation device, the outer edge thereof could float away from the intake ventilation device, and this could facilitate falling off of the filter body. Also, the effective ventilation area of the filter structure could decrease.

The distance A is more preferably within the range of 10 mm or more and 28 mm or less, and the distance B is more preferably within the range of 2 mm or more and 8 mm or less

In the filter structure of the present invention, an arrangement may be used in which the filter body has a polygonal shape in plan view, the distance A of the at least one pinched portion is a length of a line segment bisecting a vertex angle of the filter body, and having one end at the outer edge of the filter body and the other end at the outer edge of the adhesive layer, and the distance B of the at least one gusset portion is a shortest distance between one side of the filter body and the outer edge of the adhesive layer.

With this arrangement, since pinched portions can be radially located at the corners of the polygonal shape, it is possible to easily pinch and separate the release sheet. Also, since a gusset portion can be located along at least a portion of each side of the polygonal shape, it is possible to reliably prevent an adhesive agent from adhering to the slitting blade during production and cutting.

In the filter structure of the present invention, it is preferable that the filter body has a rectangular shape, and the at least one pinched portion comprises pinched portions formed at four corners of the rectangular filter body, respectively.

With this arrangement, since pinched portions are disposed at the four corners of the rectangular filter body, it is possible to easily separate the release sheet with a simple structure.

In the filter structure of the present invention, the at least one gusset portion preferably comprises gusset portions formed along four sides of the rectangular filter body, respectively.

With this arrangement, since gusset portions are disposed along the four sides of the rectangular filter body, with a simple structure, it is possible to easily prevent an adhesive agent from adhering to the slitting blade during production.

In the filter structure of the present invention, it is preferable that the filter body has a thickness of 0.2 mm or more and 10 mm or less, and the release sheet has a thickness of 1 μm or more and 50 μm or less.

If such thicknesses are used, it is possible to improve the separation properties of the release sheet at a low cost.

If the thickness of the filter body is less than 0.2 mm, the filter body will be too thin, so that the catching performance for catching dirt in air could be insufficient. If the thickness of the filter body is more than 10 mm, the weight per unit area will be too large, so that the material cost will increase, and also the filter body could separate from the intake ventilation device by its own weight.

If the thickness of the release sheet is less than 1 μm, the release sheet will be too thin, so that it could be difficult to hook a finger to the pinched portion(s) and separate the release sheet. If the thickness of the release sheet is more than 50 μm, the material cost will increase, and also the rigidity will be too large, so that the adhesion of the release sheet to the filter body will be reduced, and thus when winding the filter structure or when folding the filter structure at the packaging stage, the release sheet could separate from the filter body. Therefore, the release sheet preferably has a desired rigidity that does not generate these problems easily.

In the filter structure of the present invention, the adhesive layer may include a replacement timing indicating part for indicating replacement timing of the filter structure due to a pattern of dirt on the filter body.

Air does not substantially pass through the portion of the filter body on which the adhesive layer is laminated, and dirt hardly adheres to this portion. However, the filter body has good air permeability at its portion on which the adhesive layer is not laminated, and thus a lot of dirt adheres to this portion. Due to a pattern of the adhesive layer, the portion of the filer body that has become dirty, and the portion of the filter body that has not become dirty appear as a contrast. For example, if the filter structure is configured such that a picture or the like appears, it is possible to visually learn the timing of replacement of the filter structure with ease.

By providing the adhesive layer with such a replacement timing indicating part, it is possible to improve the convenience of the filter structure.

### Effects of the Invention

For the above-described filter structure of the present invention, even if a thin release sheet is used, the release sheet can be separated easily, and the filter structure does not fall off from the intake ventilation device, thus preventing a reduction in the ventilation capacity of the intake ventilation device.

### BRIEF DESCRIPTION OF THE DRAWINGS

FIG. 1 is a plan view of a filter structure.

FIG. 2 is a side view of the filter structure.

FIG. 3 is an enlarged plan view of the filter structure.

FIG. 4 is a plan view of a filter structure of a different example.

FIG. 5 is a plan view of a filter structure of a different example.

FIG. 6 is a plan view of a filter structure of a different example.

### BEST MODE FOR CARRYING OUT THE INVENTION

Embodiments of the present invention are described below with reference to the drawings.

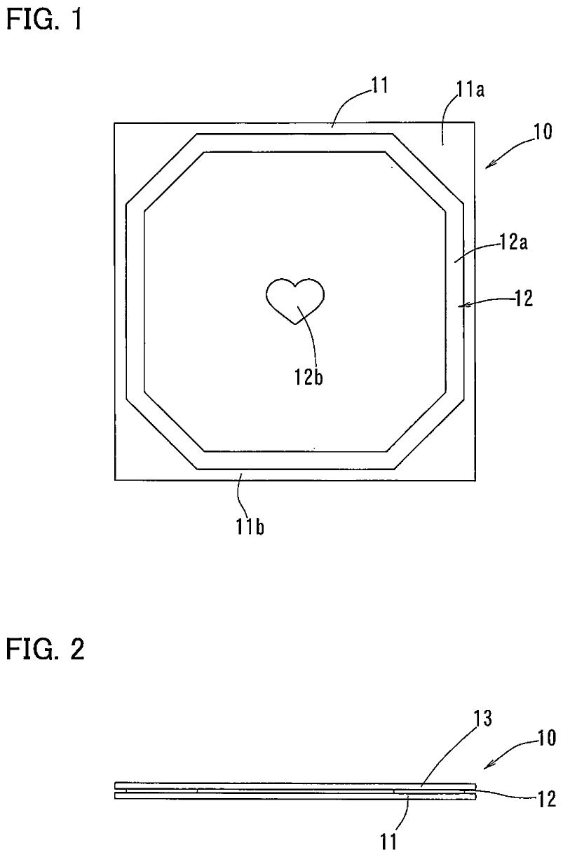

FIGS. 1 to 3 illustrate a filter structure 10 that is attached to an intake ventilation device, and that filters the air passing through the filter structure 10, thereby preventing the intake ventilation device from becoming dirty.

As illustrated in FIG. 1, the filter structure 10 has a rectangular shape in plan view so as to match or correspond to a rectangular opening of the intake ventilation device. As illustrated in FIG. 2, the filter structure 10 includes at least three layers constituted by a filter body 11, an adhesive layer 12 and a release sheet 13. The filter structure 10 may include, in addition to the three layers, a different layer such as an antibacterial layer.

When attaching the filter structure 10 to the intake ventilation device, a user separates the release sheet 13 from the filter structure 10 so as to expose the adhesive layer 12, and with the filter structure 10 opposed to the opening of the device, the user presses the filter structure 10 against the device until the filter structure 10 is bonded thereto.

The vertical and horizontal dimensions of the filter structure 10 are not particularly limited. However, if the intake ventilation device is a relatively small-sized device such as a ventilation opening installed in, e.g., the ceiling of a washroom and a toilet; an indoor air vent corresponding to a 24-hour ventilation system; or an outdoor air vent installed in, e.g., an outdoor building wall surface, each of the vertical and horizontal dimensions of the filter structure 10 can be set within the range of, e.g., 100 mm to 300 mm so as to match or correspond to the vertical or horizontal dimension of a general opening of such an intake ventilation device. Also, if the intake ventilation device is a relatively large-sized device such as a range hood installed in a kitchen, an air conditioner, an air purifier or a bathroom dryer, each of the vertical and horizontal dimensions of the filter structure 10 can be set within the range of, e.g., 250 mm to 1,000 mm as so as to match or correspond to the vertical or horizontal dimension of a general opening of such an intake ventilation device. Also, the filter structure 10 may be a long roll-shaped one.

The filter body 11 comprises a sheet body that can catch dust, oil stains, etc., and that is formed of, e.g., a nonwoven fabric, a woven fabric or a knitted fabric. The filter body 11 is preferably formed of a nonwoven fabric, which has good performance in catching dust, oil stains, etc., and is relatively low in cost.

The material of the nonwoven fabric is not particularly limited, but may be, e.g., a known natural fiber or a known synthetic fiber such as polyester fiber such as polyethylene terephthalate; polyolefin fiber such as polyethylene or polypropylene; polyamide fiber; or acrylic fiber. Also, the nonwoven fabric may be subjected to a flame-retardant treatment, an antibacterial treatment or an anti-mold treatment as necessary to such an extent that the effects of the present invention are not prevented.

When using the filter structure 10, a user separates the release sheet 13 from the filter structure 10 so as to expose the adhesive layer 12, and, with the filter structure 10 opposed to the opening of the intake ventilation device, the user presses the filter structure 10 by hand so that the filter body 11 is attached in a manner in which a seal is bonded. The filter body 11 attached to the intake ventilation device in this way filters dust, oil stains, etc. contained in the gas passing through the filter body 11, thereby reducing adhesion of dirt to the intake ventilation device.

The thickness of the filter body 11 is not particularly limited, but is preferably 0.2 mm or more and 10 mm or less. If the filter body 11 is formed of a nonwoven fabric, the weight of the filter body 11 per unit area is preferably 20 g/m² or more and 200 g/m² or less.

If the weight per unit area is less than 20 g/m², the filter body 11 will be insufficient in strength, so that the filter body 11 is likely to break during production, and also is less likely to sufficiently function to catch dust, oil stains, etc. If the weight per unit area is more than 200 g/m², the filter body 11 will deteriorate in air permeability, and this could adversely affect the intake ventilation performance of the intake ventilation device. Also, the material cost will increase, and the filter body 11 could separate from the intake ventilation device by its own weight.

The filter body 11 has a rectangular shape, and its outer edge constitutes the outer edge of the filter structure 10.

The color of the filter body 11 is also not particularly limited, but is preferably white so that the degree of dirt adhesion can be seen easily.

As illustrated in FIG. 2, the adhesive layer 12 of a predetermined pattern as shown in FIG. 1 is formed on at least one surface of the filter body 11.

The adhesive layer 12 is formed of an adhesive agent, and can be bonded to the intake ventilation device.

The kind of the adhesive agent is not particularly limited, but, for example, a two-component adhesive containing a main agent and a curing agent such as a two-component polyurethane-based adhesive, a hot-melt adhesive such as an acrylic hot-melt adhesive, or the like can be used as the adhesive agent.

The method of forming the adhesive layer 12 is not particularly limited, but as an example, it is possible to form the adhesive layer 12 by applying an adhesive agent to the filter body 11 or the release sheet 13 using an applying method such as screen printing, roll coating, spray coating or ink jetting. If an adhesive agent is applied to the release sheet 13, and then the filter body 11 is laminated onto this, the adhesive layer 12 is transferred to the filter body 11.

The ratio of the formation range of the adhesive layer 12 to the entire surface of the filter body 11, i.e., the application rate of an adhesive agent applied is not particularly limited, but is preferably 5% to 95%.

If the application rate is less than 5%, the area of the adhesive layer 12 will be too small, so that the adhesive layer 12 could fail to show sufficient adhesive performance with respect to the intake ventilation device. If the application rate is more than 95%, substantially the entire surface of the filter body 11 will be covered by the adhesive layer 12, so that the air permeability may not be ensured. However, the application rate of an adhesive agent applied is not limited to the above in a case where, as in spray coating, an amount of adhesive agent that can ensure the air permeability of the filter body 11 is formed on substantially the entire surface of the filter body 11 (for example, in a case where an adhesive agent is adhered as the adhesive layer 12 to the entire surface of the filter body 11 so as to be scattered in the form of fine grains, or where an adhesive agent is thinly applied such that the adhesive layer 12 includes portions through which air permeates).

As illustrated in FIG. 2, the release sheet 13 is laminated on the adhesive layer 12 so as to prevent the adhesive layer 12 from unintentionally adhering to an article while the filter structure 10 is not in use.

The release sheet 13 has a rectangular shape having substantially the same diameter and dimensions as the filter body 11.

The material of the release sheet 13 is not particularly limited. The release sheet 13 can be made of, e.g., paper or a resin film, but is preferably made of a resin film, which can be separated from the adhesive layer 12 easily.

The thickness of the release sheet 13 is not particularly limited, but is preferably 1 μm or more and 50 μm or less.

If the thickness of the release sheet 13 is less than 1 μm, the release sheet 13 will be too thin, and could fail to separate easily. If the thickness of the release sheet 13 is more than 50 μm, the material cost will increase, and also the rigidity will be too large, so that when winding the filter structure 10 or when folding the filter structure 10 at the packaging stage, the release sheet 13 could separate unintentionally.

The flexural hardness of the release sheet 13 is not particularly limited, but is preferably 0.0010 gf-cm²/cm or more and 0.200 gf-cm²/cm or less.

If the flexural hardness of the release sheet 13 is more than 0.200 gf-cm²/cm, when winding the filter structure 10 in the filter winding step during production or when folding the filter structure 10 in the filter packaging step, the release sheet 13 could partially separate from the adhesive layer 12 of the filter body 11.

If the flexural hardness of the release sheet 13 is less than 0.0010 gf-cm²/cm, the elasticity of the release sheet 13 will be reduced markedly, and thus the release sheet 13 will not separate from the filter structure 10 easily. Also, this could cause adhesive processing defects, for example, could cause a situation in which due to snaking of the release sheet 13 in the step of forming the adhesive layer 12 on the filter boy 11, the adhesive pattern is displaced on the right and left sides, thereby making it impossible to realize an expected function or an expected design.

For the flexural hardness, a test piece of 10 cm square is prepared by cutting the release sheet, the flexural hardness is measured using a pure bending test machine (Model No.: KES-FB2-A) made by KATO TECH CO., LTD. under the conditions of clamp interval of 1 cm, flexural deformation speed of 0.5 cm⁻¹/sec, sensitivity of 20 gf-cm and maximum curvature of 2.5 cm⁻¹.

The vertical flexural hardness and the horizontal flexural hardness of the test piece prepared are measured, and one of the measured values that is higher than the other measured value is adapted as the measured value of the flexural hardness of the release sheet.

As illustrated in FIG. 1, the adhesive layer 12 comprises an adhesive main layer part 12a having a substantially rectangular annular shape; and a replacement timing indicating part 12b having a heart shape, and disposed inside of the adhesive main layer part 12a.

The replacement timing indicating part 12b also contributes to bonding of the adhesive layer 12 to the intake ventilation device. The filter body 11 loses air permeability at its portion on which the replacement timing indicating part 12b is formed, thus creating a difference in the dirt catching performance of the filter body 11 between the portion of the filter body 11 on which the replacement timing indicating part 12b is formed and the other portion of the filter body 11.

As a result, dirt accumulates at the portion of the filter body 11 around the replacement timing indicating part 12b, and this portion darkens and discolors over time, whereas since air does not pass through the replacement timing indicating part 12b, dirt does not accumulate at the replacement timing indicating part 12b, so that the color of the portion of the filter body 11 on which the replacement timing indicating part 12b is formed remains substantially the original color of the filter body 11. Therefore, if the filter body 11 is white, this portion remains white.

Therefore, as time passes, a user can clearly visually recognize the heart shape of the replacement timing indicating part 12b due to the color contrast. Therefore, the replacement timing indicating part 12b functions as an indicator of the timing of replacement of the filter structure 10.

The shape of the replacement timing indicating part 12b is not limited to a heart shape, and may be a character's pattern or language characters/letters.

As illustrated in FIG. 1, the adhesive main layer part 12a is a rectangular annular part formed along the outer edge of the rectangular shape of the filter body 11 so as to be located somewhat away from the outer edge of the rectangular shape.

The width of the annulus of the adhesive main layer part 12a is not particularly limited, but is preferably 5 mm or more and 20 mm or less.

If the width is less than 5 mm, the bonding strength relative to the intake ventilation device could be insufficient. If the width is more than 20 mm, the effective ventilation area of the filter body 11 will decrease, so that the catching performance of the filter body 11 for catching dust, oil stains, etc. could decrease.

The outer sides of the four corners of the adhesive main layer part 12a, which correspond to the four right-angled corners of the filter body 11, are obliquely cut out, and the inner sides of the four corners of the adhesive main layer part 12a also have an oblique shape.

The filter body 11 includes tab-shaped pinched portions 11a at its areas which are located between the four corners of the outer edge of the filter body 11 and the four corners of the outer edge of the adhesive main layer part 12a, and on which the adhesive layer is not formed.

When using the filter structure 10, it is possible to easily separate the release sheet 13 by pinching one of the pinched portions 11a.

While the adhesive forces of the four corners could be reduced by forming the pinched portions 11a, by making the inner sides of the four corners of the annulus of the rectangular annular adhesive main layer part 12a not right-angled but inclined or curved, it is possible to prevent the adhesive areas (or the adhesive forces) at the corners from becoming insufficient. Provided that the effective ventilation area of the filter body 11 does not decrease significantly, it is possible to ensure an adhesive force by inclining or curving the inner sides of the four corners of the annulus of the adhesive main layer part 12a.

As illustrated in FIG. 1, the filter body 11 further includes strip-shaped gusset portions 11b extending along the four sides of the filter body 11a, and disposed at the areas of the filter body 11 which are located between the four sides of the outer edge of the filter body 11 excluding the four corners and the four sides of the outer edge of the adhesive main layer part 12a excluding the four corners, and on which the adhesive layer is not formed.

Since the gusset portions 11b are disposed along the outer edges of the filter structure 10 at its four sides, when, with a slitting blade, cutting the filter structure 10 into a rectangular shape from a roll-shaped sheet, an adhesive agent does not adhere to the slitting blade, so that productivity is not affected, e.g., a situation in which the blade cannot cut the filter structure smoothly does not occur.

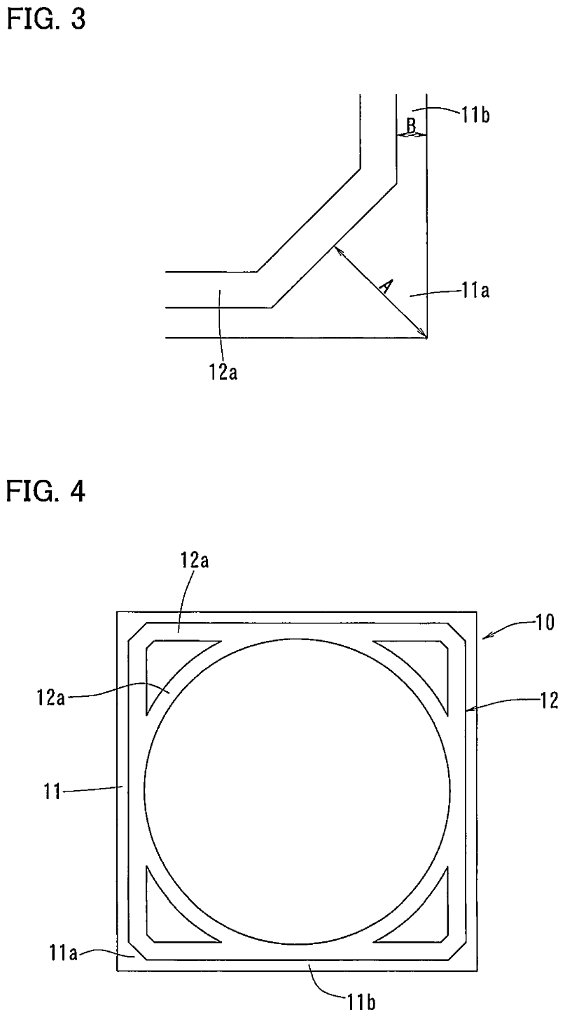

As illustrated in FIG. 3, the width of each pinched portion 11a is defined by a distance A between the corresponding one of the outer edges of the filter body 11 at its four corners and the corresponding one of the outer edges of the adhesive layer 12 at its four corners, and the distance A is 9 mm or more and 35 mm or less.

In the shown example, the distance A corresponds to the length of a line segment bisecting the vertex angle of the filter body 11, and having one end at the outer edge of the filter body 11 and the other end at the outer edge of the adhesive layer 12.

If the distances A of the pinched portions 11a are more than 35 mm, the filter structure 10 could separate and fall off from the intake ventilation device starting from the pinched portions 11a.

If the distances A of the pinched portions 11a are less than 9 mm, it could be difficult to pinch the pinched portions 11a, and separate the release sheet 13.

As illustrated in FIG. 3, the width of each gusset portion lib is defined by a distance B between the corresponding one of the outer edges of the filter body 11 at its four sides and the outer edge of the adhesive layer 12, and the distance B is set to satisfy the inequality “distance B<distance A”.

In the shown example, the distance B corresponds to the shortest distance (perpendicular line length) between one side of the filter body 11 and the outer edge of the adhesive layer 12.

Since, if the gusset portions lib are formed, the distances B of each gusset portion lib is generally about 5 mm, if the distance A is within the above numerical range, the above inequality is satisfied.

The distance B is preferably 1 mm or more and 9 mm or less.

If the distance B is less than 1 mm, the width will be too small, so that when cutting the filter structure 10 with a slitting blade, an adhesive agent could adhere to the slitting blade depending on variations in the dimensions of the filter structure 10.

If the distance B is more than 9 mm, when attaching the filter body 11 to an intake ventilation device, the filter body 11 could float away from the intake ventilation device, and this could facilitate falling off of the filter body 11.

### EXAMPLES

The contents of the present invention are further clarified by presenting Examples of the present invention, Comparative Examples and a Reference Example below.

The below-described filter structures were prepared as the filter structures of the Examples, Comparative Examples and Reference Example

The below-described filter structures are all three-layer structures each comprising a filter body formed of a nonwoven fabric of which the weight per unit area is 40 g/m²; an adhesive layer; and a release sheet.

The adhesive layers of Examples 1 to 5 have the same pattern as in the shown example, i.e., a rectangular annular pattern of which the four corners are partially missing; and the adhesive layers of Comparative Examples 1 to 3 have a rectangular annular pattern including right-angled four corners (shape similar to the outer edge of the filter body). The widths of the adhesive layers were all set to 10 mm. The adhesive layers do not include a replacement timing indicating part.

The overall dimensions of each filter structure were set to 160 mm×160 mm.

### Example 1

Distance A: 13 mm
Distance B: 5 mm
Release sheet thickness: 15 μm

### Example 2

Distance A: 9 mm
Distance B: 5 mm
Release sheet thickness: 3 μm

### Example 3

Distance A: 30 mm
Distance B: 5 mm
Release sheet thickness: 40 μm

### Example 4

Distance A: 21.2 mm
Distance B: 15 mm
Release sheet thickness: 15 μm

### Example 5

Distance A: 35 mm
Distance B: 5 mm
Release sheet thickness: 15 μm

### Comparative Example 1

Distance A: 7 mm
Distance B: 5 mm
Release sheet thickness: 15 μm

### Comparative Example 2

Distance A: 0 mm
Distance B: 0 mm
Release sheet thickness: 15 μm

### Comparative Example 3

Distance A: 7 mm
Distance B: 5 mm
Release sheet thickness: 50 μm

### Reference Example 1

Distance A: 7 mm
Distance B: 5 mm
Release sheet thickness: 140 μm

With respect to the filter structures of the Examples, Comparative Examples and Reference Example, tests were conducted to confirm how easily the release sheets can be separated.

The time required from the start of separation of the release sheet from each filter structure to complete separation of the release sheet is referred to as the “separation time”. The separation time for separating the release sheet from each filter structure was measured under the cooperation of ten cooperators.

It can be said that the shorter the separation time, the easier separation of the release sheet.

The results are shown in Table 1.

Also, with respect to the filter structures of the Examples, Comparative Examples and Reference Example, tests were conducted to confirm how easily the filter bodies can be detached from an intake ventilation device.

By attaching each filter structure from which the release sheet was separated to a ventilation fan installed to the ceiling of a washroom, and then detaching the filter structure from the ventilation fan, a sensory evaluation was conducted using two options “detachable easily” and “not detachable easily” to confirm how easily the filter structure was detached therefrom.

The results are shown in Table 1.

In Table 1, ◯ means that the number of cooperators which chose “detachable easily” was 8 or more and 10 or less; A means that the number of cooperators which chose “detachable easily” was 3 or more and 7 or less; and x means that the number of cooperators which chose “detachable easily” was 2 or less.

Also, tests were conducted to confirm the effective ventilation areas of the filter structures according to the Examples, Comparative Examples and Reference Example.

With the release sheet separated from each filter structure, the portion of the filter structure disposed inwardly of the adhesive layer was measured as the effective ventilation area of the filter structure.

Also, with respect to each of the filter structures according to the Examples, Comparative Examples and Reference Example, an evaluation test was conducted to confirm whether or not the release sheet was separated when the filter structure was folded.

When each of the filter structures according to the Examples, Comparative Examples and Reference Example was folded into two at its central portion such that the release sheet faced the outer side, it was confirmed whether or not the release sheet was separated from the adhesive layer of the filter structure.

Each filter structure was evaluated as “separated” in a case where even a portion of the release sheet was separated, and evaluated as “not separated” in a case where the release sheet was not separated.

The results are shown in Table 1.

TABLE 1

| | | | | | | Comparative | Comparative | Comparative | Reference |
|---|---|---|---|---|---|---|---|---|---|
| | Example 1 | Example 2 | Example 3 | Example 4 | Example 5 | Example 1 | Example 2 | Example 3 | Example 1 |
| Separation time (seconds) | 4.06 | 4.30 | 3.60 | 3.98 | 3.65 | 5.77 | 20.79 | 3.88 | 3.65 |
| Easy detachment | ∘ | ∘ | ∘ | ∘ | ∘ | x | x | x | ∘ |
| Effective ventilation area (cm²) | 169.00 | 169.00 | 154.88 | 121.00 | 146.37 | 169.00 | 196.00 | 169.00 | 169.00 |
| Release sheet thickness (μm) | 15 | 3 | 40 | 15 | 15 | 15 | 15 | 50 | 140 |
| Flexural hardness (gf · cm²/cm) | 0.0111 | 0.0016 | 0.0743 | 0.0111 | 0.0111 | 0.0111 | 0.0111 | 0.0856 | 0.25 |
| Whether or not the release sheet | Not | Not | Not | Not | Not | Not | Not | Not | Separated |
| was separated when the filter | separated | separated | separated | separated | separated | separated | separated | separated | |
| structure was folded | | | | | | | | | |

The above-described embodiment is mere an example in every respect, and the present invention is not limited thereto. The scope of the present invention is indicated by the claims, and should be understood to include all modifications and variations within the scope of the claims and within the meaning equivalent to the scope of the claims.

For example, the overall shapes of the filter structure 10 and the filter body 11 are not limited to rectangular shapes as in the embodiment, and may be polygonal or circular shapes, which are shapes other than rectangular shapes.

The pattern and shape of the adhesive main layer part 12a of the adhesive layer 12 are also not limited to rectangular annular ones as in the embodiment, and may be different ones such as polygonal annular or circular annular ones. The adhesive layer 12 may include a different adhesive main layer part inwardly of the adhesive main layer part 12a.

The filter structure 10 includes the filter body 11, the adhesive layer 12 and the release sheet 13 as the minimum elements, and may further include a different layer in addition to these elements.

The shapes, locations and numbers of the pinched portions 11a and the gusset portions 11b are also not limited to the embodiment.

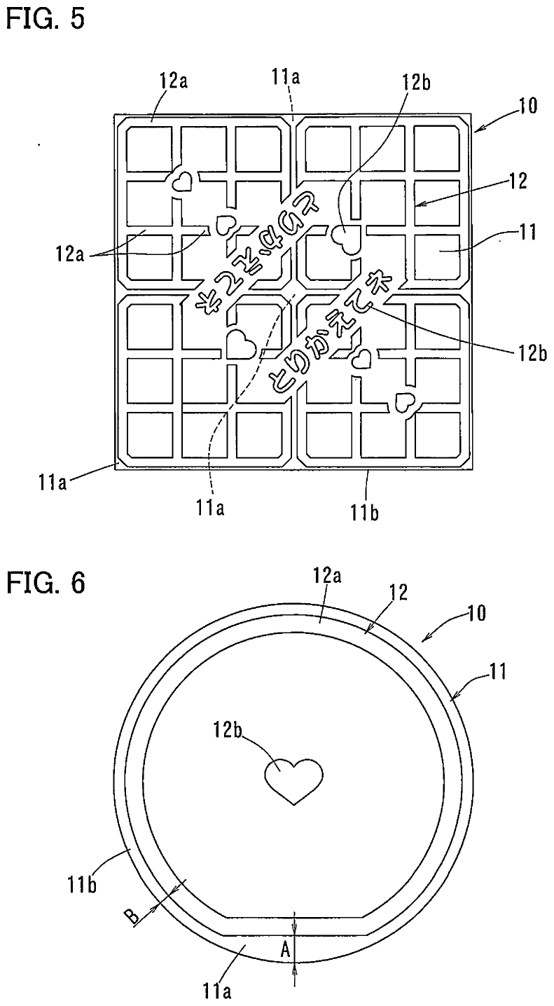

The shape of the replacement timing indicating part 12b is also not limited to a heart shape as in the embodiment. The replacement timing indicating part 12b may comprise a character's pattern or language characters/letters as in the example of FIG. 5, which is described later. Also, the replacement timing indicating part 12b may be omitted as in the example of FIG. 4, which is described later.

In view of the above, FIG. 4 illustrates a filter structure 10 of a different example.

In this example, a circular annular adhesive main layer part 12a is formed inwardly of a substantially rectangular annular adhesive main layer part 12a as shown in the embodiment of FIG. 1.

The circular annular adhesive main layer part 12a is located to come into contact with (the circular annular adhesive main layer part 12a may be located close to) the central portions of the sides of the substantially rectangular annular adhesive main layer part 12a. Therefore, while the adhesive forces of the filter body 11 at the four corners could be reduced by forming the pinched portions 11a at the filter body 11, the circular annular adhesive main layer part 12a also contributes to attachment of the portions of the filter body 11 near the four corners to an intake ventilation device.

That is, the circular annular adhesive main layer part 12a also contributes to adhesion. Also, if such a filter structure is used, compared to a filter structure that does not include the circular annular adhesive main layer part 12a, large adhesive forces are not required as the adhesive forces of the adhesive main layer part 12a at the four corners of the filter body 11 that are required for preventing the filter body 11 from separating from the intake ventilation device. Therefore, it is possible to more reliably prevent falling off of the filter body 11 due to separation of the four corners.

In this example, the replacement timing indicating part 12b is not formed.

FIG. 5 illustrates a filter structure 10 of a still different example.

In this example, a lattice-shaped adhesive main layer part 12a is formed inwardly of a substantially rectangular annular adhesive main layer part 12a as shown in the embodiment of FIG. 1.

As in the example of FIG. 4, the lattice-shaped adhesive main layer part 12a prevents falling off of the filter body 11 due to separation of the four corners.

The filter structure 10 of FIG. 5 includes replacement timing indicating parts 12b comprising heart-shaped parts disposed at appropriate places; and a pair of parts constituted by Japanese characters meaning “replace” and disposed to be point-symmetrical with respect to the center of the filter structure 10.

Also, in this example, not only the four corners of the substantially rectangular annular adhesive main layer part 12a, but also the midpoints of the four sides thereof and the lattice corners of the lattice-shaped adhesive main layer part 12a at the center of the filter structure 10 have an oblique shape.

With this arrangement, according to the dimensions of the intake ventilation device, it is possible to easily cut the filter structure 10 into a smaller filter structure using the oblique-shaped lattice corners as a mark. Also, if the filter structure 10 is cut into a smaller filter structure, a pinched portion 11a is automatically formed between the oblique-shaped lattice corner and the corner of the smaller filter structure (In FIG. 5, a broken line is used as the drawn-out line for the pinched portion 11a formed after cutting). Therefore, it is possible to easily separate the release sheet, and improve convenience.

Of course, the circular annular adhesive main layer part 12a of FIG. 4 and the lattice-shaped adhesive main layer part 12a of FIG. 5 may be combined together.

FIG. 6 illustrates a filter structure 10 of a yet different example.

In this example, the filter body 11 has a circular shape in plan view.

The adhesive layer 12 has a substantially circular annular shape extending along the outer edge of the filter body 11 and slightly spaced apart from this outer edge, and a portion of the adhesive layer 12 is straight cut out.

A pinched portion 11a is formed at the area which is located between the outer edge of the filter body 11 and the outer edge of the straight cut out portion of the adhesive layer 12, and on which the adhesive layer 12 is not formed.

Also, a gusset portion 11b is formed at the area which is located between the outer edge of the filter body 11 and the outer edge of the other portion of the adhesive layer 12, and on which the adhesive layer 12 is not formed.

The width of the pinched portion 11a is defined by a distance A between the outer edge of the filter body 11 and the outer edge of the straight cut out portion of the adhesive layer 12, and the distance A is 5 mm or more and 35 mm or less, and preferably 9 mm or more. The distance A is set within this range due to the same reason as described above with respect to the polygonal filter structure.

The width of the gusset portion 11b is defined by a distance B between the outer edge of the filter body 11 and the portion of the adhesive layer 12 other than the cut out portion, and the distance B is set to satisfy the inequality “distance B<distance A” as is apparent from FIG. 6. The distance B is preferably 1 mm or more and 8 mm or less. The distance B is set within this range due to the same reason as described above with respect to the polygonal filter structure.

By pinching the pinched portion 11a, it is possible to easily separate the release sheet 13.

In this example, too, the circular annular adhesive main layer part 12a of FIG. 4, the lattice-shaped adhesive main layer part 12a of FIG. 5 or the combination of these layer parts may be added.

### DESCRIPTION OF REFERENCE NUMERALS

10: Filter structure
11: Filter body
11a: Pinched portion
11b: Gusset portion
12: Adhesive layer
12a: Adhesive main layer part
12b: Replacement timing indicating part
13: Release sheet

1. A filter structure attachable to an intake ventilation device so as to prevent dirt in the intake ventilation device, the filter structure having a polygonal shape in plan view and comprising at least:
a filter body;
an adhesive layer partially formed on one surface of the filter body, and formed of an adhesive agent; and
a release sheet laminated on the adhesive layer,
wherein the filter body includes at least one pinched portion which is in contact with a portion of an outer edge of the filter body, and on which the adhesive layer is not formed, and
wherein the at least one pinched portion has a width defined by a distance A between the outer edge of the filter body and an outer edge of the adhesive layer, which is located inwardly of the outer edge of the filter body, and the distance A is 9 mm or more and 35 mm or less.

2. A filter structure attachable to an intake ventilation device so as to prevent dirt in the intake ventilation device, the filter structure having a circular shape in plan view and comprising at least:
a filter body;
an adhesive layer partially formed on one surface of the filter body, and formed of an adhesive agent; and
a release sheet laminated on the adhesive layer,
wherein the filter body includes a pinched portion which is in contact with a portion of an outer edge of the filter body, and on which the adhesive layer is not formed, and
wherein the pinched portion has a width defined by a distance A between the outer edge of the filter body and an outer edge of the adhesive layer, which is located inwardly of the outer edge of the filter body, and the distance A is 5 mm or more and 35 mm or less.

3. The filter structure according to claim 1, wherein the filter body further includes, at an area other than the at least one pinched portion, at least one gusset portion which extends along the outer edge of the filter body, and on which the adhesive layer is not formed, and
wherein the at least one gusset portion has a width defined by a distance B between the outer edge of the filter body and the outer edge of the adhesive layer, which is located inwardly of the outer edge of the filter body, and the distance B is set to satisfy “distance B<distance A”.

4. The filter structure according to claim 2, wherein the filter body further includes, at an area other than the pinched portion, a gusset portion which extends along the outer edge of the filter body, and on which the adhesive layer is not formed, and
wherein the gusset portion has a width defined by a distance B between the outer edge of the filter body and the outer edge of the adhesive layer, which is located inwardly of the outer edge of the filter body, and the distance B is set to satisfy “distance B<distance A”.

5. The filter structure according to claim 3, wherein the distance A of the at least one pinched portion is 9 mm or more and 30 mm or less, and
wherein the distance B of the at least one gusset portion is 1 mm or more and 8 mm or less.

6. The filter structure according to claim 4, wherein the distance A of the pinched portion is 9 mm or more and 30 mm or less, and
wherein the distance B of the gusset portion is 1 mm or more and 8 mm or less.

7. The filter structure according to claim 3, wherein the filter body has a polygonal shape in plan view,
wherein the distance A of the at least one pinched portion is a length of a line segment bisecting a vertex angle of the filter body, and having one end at the outer edge of the filter body and the other end at the outer edge of the adhesive layer, and
wherein the distance B of the at least one gusset portion is a shortest distance between one side of the filter body and the outer edge of the adhesive layer.

8. The filter structure according to claim 1, wherein the filter body has a rectangular shape, and
wherein the at least one pinched portion comprises pinched portions formed at four corners of the rectangular filter body, respectively.

9. The filter structure according to claim 3, wherein the filter body has a rectangular shape,
wherein the at least one pinched portion comprises pinched portions formed at four corners of the rectangular filter body, respectively, and
wherein the at least one gusset portion comprises gusset portions formed along four sides of the rectangular filter body, respectively.

10. The filter structure according to claim 1, wherein the filter body has a thickness of 0.2 mm or more and 10 mm or less, and
wherein the release sheet has a thickness of 0.001 mm or more and 0.050 mm or less.

11. The filter structure according to claim 2, wherein the filter body has a thickness of 0.2 mm or more and 10 mm or less, and
wherein the release sheet has a thickness of 0.001 mm or more and 0.050 mm or less.

12. The filter structure according to claim 1, wherein the adhesive layer includes a replacement timing indicating part for indicating replacement timing of the filter structure due to a pattern of dirt on the filter body.

13. The filter structure according to claim 2, wherein the adhesive layer includes a replacement timing indicating part for indicating replacement timing of the filter structure due to a pattern of dirt on the filter body.
